(19) United States
(12) Patent Application Publication
(10) Pub. No.: US 2023/0319093 A1
(43) Pub. Date: Oct. 5, 2023

(54) Containerized network activity filtering

(71) Applicant: Sophos Limited, Abingdon (GB)

(72) Inventors: Biju Ramachandra Kaimal, Bangalore (IN); Jeffrey Martin Green, Brentwood, TN (US)

(21) Appl. No.: 17/752,256

(22) Filed: May 24, 2022

(30) Foreign Application Priority Data
Mar. 31, 2022 (IN) 202211019564

(51) Int. Cl. H04L 9/40; H04L 61/4511

(52) U.S. Cl. CPC H04L 63/1433; H04L 61/4511; H04L 63/10; H04L 63/145; H04L 63/0281

(57) ABSTRACT

Systems and methods for operating a container-based architecture. The methods include executing, using one or more processors, instructions stored on memory to provide a Domain Name Service (DNS) proxy service, wherein the DNS proxy service is executed in a container-based architecture; and receiving at the DNS proxy service a domain name service (DNS) request, wherein the DNS request is received from an application service executing in the container-based architecture and the DNS request is directed to a DNS service being executed in the same container-based architecture as the DNS proxy service. The methods further include analyzing, at the DNS proxy service, the received DNS request to determine whether the DNS request is intended for a malign network; assigning a classification to the DNS request using the DNS proxy service, wherein the assigned classification is based on the analysis of the received DNS request to determine whether the DNS request is intended for a malign network location; and processing the DNS request based on the assigned classification of the DNS request.

### CROSS-REFERENCE TO RELATED APPLICATIONS

The present application is the domestic filing of and claims the benefit of co-pending Indian Patent Application No. 202211019564, filed in India on Mar. 31, 2022.

### TECHNICAL FIELD

The present application relates generally to systems and methods for filtering network activity and, more particularly but not exclusively, to systems and methods for filtering network activity in a container-based architecture.

### BACKGROUND

Containers and the components they contain communicate with the Internet to download, upload, or otherwise transfer data. With the rising popularity of containerization, there has been an increase in malware targeting software running in containers. Malware may leverage container vulnerabilities as beachheads to download further malware, escalate privileges, exfiltrate data residing within containers, or some combination thereof.

To perform these tasks, malware often communicates with a command-and-control server to receive further instructions or to transfer data. Specifically, malware in a container may issue domain name service (DNS) requests to reach the command-and-control server or other malign network location.

Administrators of networks using containerized environments may also want to control container access to sites or other network locations. For example, an administrator may wish to control communications with sites or other locations that do not comply with a corporate policy.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

Embodiments herein provide systems and methods for operating a container-based architecture. A DNS proxy service is injected into a container-based architecture (e.g., an environment in which multiple containers or pods are executed). The DNS proxy service may be positioned to receive requests from application services executing in the container-based architecture before the requests reach one or more DNS servers, and may be configured to filter the DNS requests issued by the application services. Depending on an assigned classification of a DNS request, the DNS proxy service may allow the request or deny the request.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a block diagram of a threat management system in accordance with one embodiment;

FIG. 2 illustrates a block diagram a system for operating container-based architectures in accordance with one embodiment;

FIG. 3 illustrates a container-based architecture in accordance with one embodiment;

FIG. 4 depicts a flowchart of a method for operating a container-based architecture in accordance with one embodiment; and

FIG. 5 depicts a flowchart of a method for operating a container-based architecture in accordance with another embodiment.

### DETAILED DESCRIPTION

Various embodiments are described more fully below with reference to the accompanying drawings, which form a part hereof, and which show specific embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

As discussed previously, container environments may suffer from threats in which malware, once in a container environment, attempts to contact a command-and-control server or other malign location. This contact may be to receive further instructions or to perform other steps to advance a malicious campaign.

An administrator of a container-based network or environment may want to ensure compute instances in the container environment comply with a corporate policy (e.g., gambling websites, advertisement sites, etc). For example, an administrator may want to block attempts by a container to contact malicious or potentially-malicious Uniform Resource Locators (URLs).

Even if certain URLs are blocked by a network (e.g., they are on a blacklist), domain generation algorithms (DGAs) may continuously generate domains associated with a malware family. However, only a small number of generated domains would resolve to an actual, command and control server internet protocol (IP) address.

The embodiments herein provide novel systems and methods for operating a container-based architecture. Specifically, the embodiments herein implement a DNS proxy service in a container-based architecture to filter DNS requests from one or more application services executing in the container-based architecture. By intercepting DNS requests from application services within a container-based architecture, the DNS proxy service can classify the requests and, where appropriate, prevent a DNS request from being resolved.

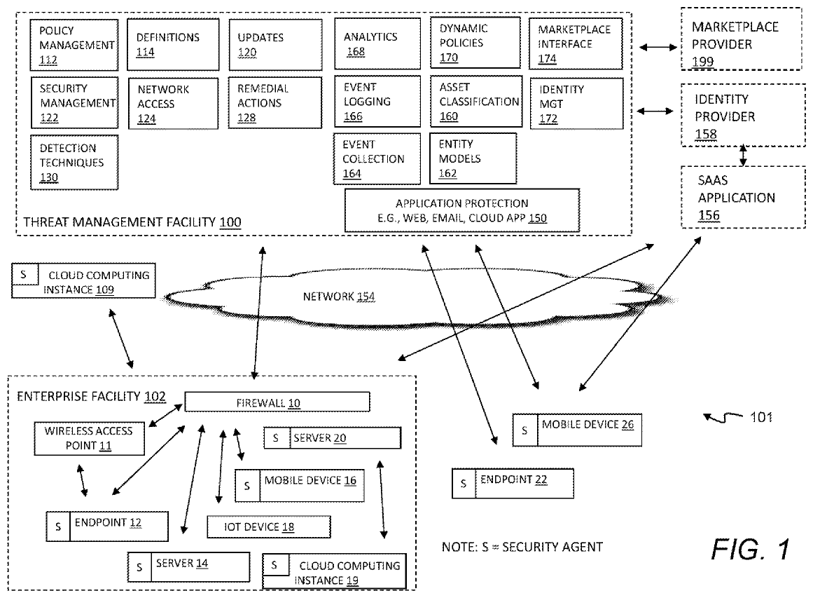

FIG. 1 illustrates a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the threat management system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

As one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, the enterprise facility 102 may be or may include any networked computer-based infrastructure. For example, the enterprise facility 102 may be corporate, commercial, organizational, educational, governmental, or the like. As home networks become more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is by way of example, and it will be understood that there may be any number of compute instances, less or more of each type of compute instances, and other types of compute instances. As shown, the enterprise facility includes a firewall 10, a wireless access point 11, an endpoint 12, a server 14, a mobile device 16, an appliance or Internet-of-Things (IOT) device 18, a cloud computing instance 19, and a server 20. Again, the compute instances 10-20 depicted are by way of example, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access facility 124, remedial action facility 128, detection techniques facility 130, application protection 150, asset classification facility 160, entity model facility 162, event collection facility 164, event logging facility 166, analytics facility 168, dynamic policies facility 170, identity management facility 172, and marketplace interface facility 174, as well as other facilities. For example, there may be a testing facility, a threat research facility, and other facilities (not shown). It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility 102. Some or all of one or more of the facilities 100, 112-174 may be provided on the same physical hardware or logical resource as a gateway, such as a firewall 10, or wireless access point 11. Some or all of one or more of the facilities 100, 112-174 may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider 199 may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider 199 may be a specialized analytics provider; and so on. The marketplace provider 199, with appropriate permissions and authorization, may receive and send events, observations, inferences, controls, convictions, policy violations, or other information to the threat management facility 100. For example, the marketplace provider 199 may subscribe to and receive certain events, and in response, based on the received events and other events available to the marketplace provider 199, send inferences to the marketplace interface facility 174, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider 158 may be any system or entity that creates, maintains, and manages identity information for principals while providing authentication services to relying party applications, e.g., within a federation or distributed network. The identity provider 158 may, for example, offer user authentication as a service, where other applications, such as web applications, outsource the user authentication step(s) to a trusted identity provider.

In embodiments, the identity provider 158 may provide user identity information, such as multi-factor authentication, to a software-as-a-service (SaaS) application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 or other type of computing device outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop or other type of public location. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22 or 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Examples of commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an internetwork 154 such as the Internet or any other public network, private network or combination thereof.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to the facility 100. Alternatively, the threat management facility 100 may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in a security agent of an endpoint 12, in a wireless access point 11 or firewall 10, as part of application protection 150 provided by the cloud, and so on.

In an embodiment, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, or unwanted applications; help control web browsing; and the like, which may provide comprehensive web access control to enable safe and productive web browsing. Web security and control may provide Internet use policies, reporting on suspect compute instances, security and content filtering, active monitoring of network traffic, Uniform Resource Identifier (URI) filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Examples of rules include access permissions associated with networks, applications, compute instances, users, content, data, and the like. The policy management facility 112 may use a database, a text file, other data store, or a combination to store policies. In an embodiment, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. These policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of Universal Serial Bus (USB) disks, and the policy management facility 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access.

The policy management facility 112 may also require update management (e.g., as provided by the update facility 120). Update management for the security management facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security management facility 122 and policy management facility 112 may push information to the enterprise facility 102 network and/or the compute instances 10-26, the enterprise facility 102 network and/or compute instances 10-26 may pull information from the security management facility 122 and policy management facility 112, or there may be a combination of pushing and pulling of information. For example, the enterprise facility 102 network and/or compute instances 10-26 may pull update information from the security management facility 122 and policy management facility 112 via the update facility 120, an update request may be based on a time period, by a certain time, by a date, on demand, or the like. In another example, the security management facility 122 and policy management facility 112 may push the information to the enterprise facility's 102 network and/or compute instances 10-26 by providing notification that there are updates available for download and/or transmitting the information. In an embodiment, the policy management facility 112 and the security management facility 122 may work in concert with the update facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22,26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, macOS, OS X, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility 100 may include the entity model facility 162. The entity models may be used, for example, to determine the events that are generated by assets. For example, some operating systems may provide useful information for detecting or identifying events. For examples, operating systems may provide process and usage information that accessed through an application programming interface (API). As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. One example of an event is the communication of a specific packet over the network. Another example of an event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 128 may take any steps or deploy any measures suitable for addressing a detection of a threat, potential threat, policy violation or other event, code or activity that might compromise security of a computing instance 10-26 or the enterprise facility 102.

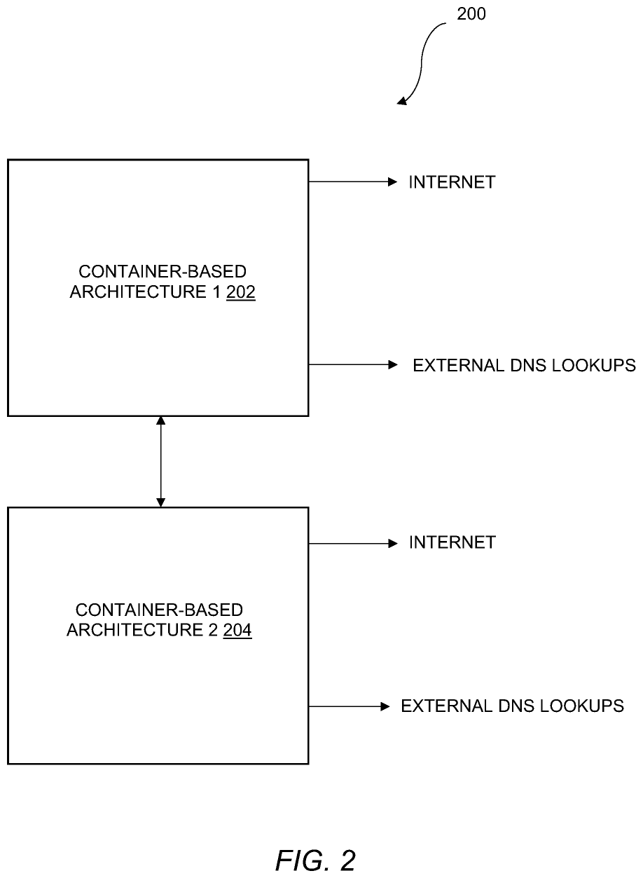

FIG. 2 illustrates a system 200 for operating a plurality of container-based architectures in accordance with one embodiment. The system 200 may include a first container-based architecture 202 (e.g., a first node in a container-based cluster) and a second container-based architecture 204 (e.g., a second node in a container-based cluster) in communication with the first container-based architecture 204.

Each container-based architecture 202 and 204 may be in communication with or otherwise access one or more networks such as the Internet. The architectures 202 and 204 or computing instances thereof may also be configured to perform external DNS lookups as part of resolving DNS requests.

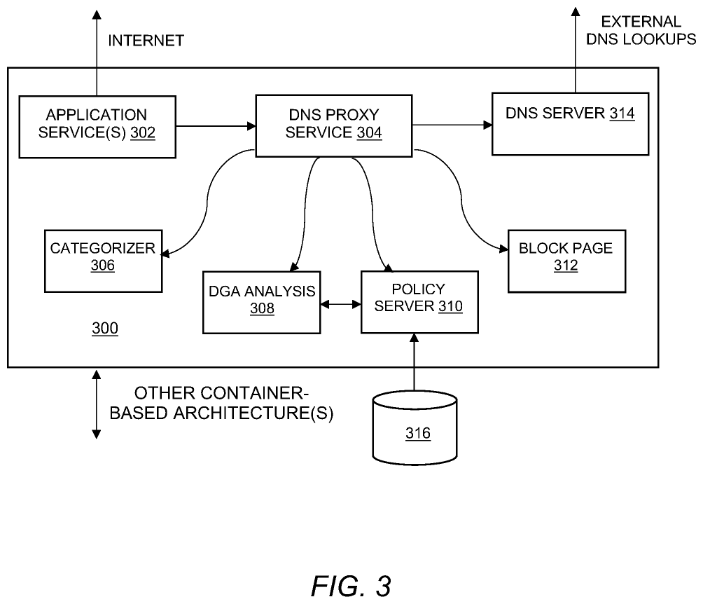

FIG. 3 illustrates a container-based architecture 300 in accordance with one embodiment. The container-based architecture 300 may be similar to the first or second container-based architectures 202 or 204, respectively, of FIG. 2.

As seen in FIG. 3, the container-based architecture 300 may include or otherwise execute one or more application services 302, a DNS proxy service 304, a categorization module 306, a DGA behavioral analysis engine 308, a policy server 310, and a block page service 312. The container-based architecture 300 may also include a DNS server 314 to, if authorized, receive submitted DNS requests. Each of these components may be implemented as part of a pod of one or more containers as provided by a framework such as the KUBERNETES® framework.

The application service(s) 302 may execute within one or more pods with shared network storage and network resources. The application service(s) 302 of FIG. 3 may be in communication with the Internet and may be configured to perform one or more specified tasks. As seen in FIG. 3, the application service(s) 302 may communicate a DNS request to access some domain to the DNS proxy service 304.

A DNS proxy service such as the service 304 may be installed on each node or server computer of a container cluster. For example, and with reference to FIG. 2, each container-based architecture 202 and 204 may be configured with a DNS proxy service such as service 304. The DNS proxy service 304 can be injected in a container-based architecture downstream from the DNS server 314 or other native DNS service and without requiring further reconfiguration to any application service(s) thereon.

The DNS proxy service 304 may be injected into the container environment 300 to help detect and block attempts to reach malicious or potentially malicious domains. For example, the DNS proxy service 304 may be configured to block attempts to reach sites that are on a blacklist or blocked by an administrator. In some embodiments, positioning the DNS proxy service in the container environment 300 may involve running the DNS proxy at a known IP address instead of the DNS server.

The DNS proxy service 304 may be in communication with one or more of various other components or modules. The DNS proxy service 304 may reference the categorization module 306, the DGA behavioral analysis engine 308, the policy server 310, or some combination thereof to process a received DNS request.

The categorization module 306 may assign a category to a received DNS request based on one or more characteristics associated therewith. For example, the categorization module 306 may identify which DNS server the DNS request is targeting, the network zone of the server the DNS request is targeting, the DNS recursor involved in servicing the DNS request, the root name server involved in servicing the DNS request, the top-level domain (TLD) server involved in servicing the DNS request, or some combination thereof. Any one or more of these attributes associated with a DNS request may provide insight into the type of DNS request or the DNS server the application service 302 is attempting to reach. The categorization module 306 may also consult one or more lists (e.g., whitelists, graylists, blacklists, etc.) to assign a category to the DNS request. Accordingly, the categorization module 306 may provide the DNS proxy service 304 with some categorization label that at least assists the DNS proxy service 304 in determining how to process the DNS request.

The DGA behavioral analysis engine 308 may execute one or more machine learning procedures to analyze the DNS request with respect to domain names generated by a DGA. Malicious actors may execute one or more DGAs to generate hundreds or thousands of domain names as part of a malware campaign. These generated domains may be associated with a malware family and share characteristics with other domain names that are part of the same family.

The analysis engine 308 may execute any appropriate machine learning procedures such as logistic regression-based models or random forest models. For example, the policy server 310 may store data structures such as two-dimensional tables or lists of benign domain names and malicious or potentially malicious domain names. More specifically, machine learning models may be trained offline on lists of benign domain names and malicious domain names. The analysis engine 308 may consider patterns or data associated with domains in this data to classify a DNS request.

For example, each level in a decision tree may represent some feature or characteristic of a domain name and whether a DNS request is associated with a domain name that possesses said characteristic. The traversal of the decision tree may result in a classification or a suggested classification of the DNS request. Accordingly, the analysis engine 308 may provide the DNS proxy service 304 with some classification that at least assists the DNS proxy service 304 in determining how to process the DNS request.

The policy server 310 may store data such as lists of benign and malicious domain names as discussed above, and may store the computed machine learning model(s) for classification. Similarly, the policy server 310 may receive this type of data from one or more databases 316. The DNS proxy service 304 may also reference the policy server 310 for determining how to process output(s) from the categorization module 306, the analysis engine 308, or both.

For example, the policy server 310 may require the DNS proxy service 304 to forward the DNS request to the corresponding DNS server upon the categorization module 306 and the analysis engine 308 both providing a “benign” classification. As another example, the policy server 310 may require the DNS proxy service 304 to deny a DNS request upon either the categorization module 306 or the analysis engine 308, or both, determining the DNS request is associated with or otherwise intended for a malign network location.

The DNS proxy service 304 may then forward the DNS request to a network location based on the classification of the DNS request. For example, if the DNS request is classified as benign (i.e., it is intended for a malign network location), the DNS proxy service 304 may allow the DNS request to access the corresponding DNS server 314.

If the DNS request is classified as malicious or otherwise being associated with a threat, the DNS proxy service 304 may block the DNS request or direct the DNS request to a sinkhole network location or a block page service 312. Or, the DNS proxy service 304 may ignore the request.

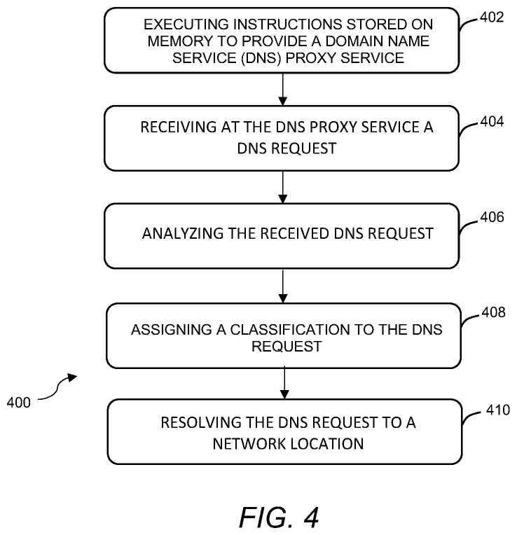

FIG. 4 depicts a flowchart of a method 400 for operating a container-based architecture. The systems or components of any one of FIGS. 1-3 may perform the steps of method 400.

Step 402 involves executing, using one or more processors, instructions stored on memory to provide a Domain Name Service (DNS) proxy service. The DNS proxy service may execute in a container-based architecture and be located downstream from one or more servers (e.g., a DNS server) to filter DNS requests.

Step 404 involves receiving at the DNS proxy service a DNS request. The DNS request may be received from an application service executing in the container-based architecture and may be directed to a DNS service being executed in the same container-based architecture as the DNS proxy service.

The DNS request may be a benign request in that it is directed towards a benign (i.e., non-malicious) server or network location. The DNS request may instead be directed towards a command-and-control server associated with a malicious actor or campaign. In the latter case, it is desirable for the DNS proxy service to recognize the DNS request as being malicious and to prevent the DNS request from resolving to an address for the desired server.

Step 406 involves analyzing, at the DNS proxy service, the received DNS request to determine whether the DNS request is intended for a malign network location. The DNS proxy service may compare the DNS request to whitelists, blacklists, etc., to determine whether the DNS request is at least likely associated with malware.

Additionally, or alternatively, the embodiments herein may execute one or more machine learning procedures to determine whether the DNS request is at least likely associated with malware. For example, and as discussed previously, embodiments herein may execute a random forest decision tree classifier to analyze the DNS request.

Step 408 involves assigning a classification to the DNS request using the DNS proxy service. The assigned classification is based on the analysis of the received DNS request discussed above.

Step 410 involves resolving the DNS request to a network location based on the assigned classification of the DNS request. For example, if the DNS request is classified as being associated with malware (e.g., it is directed towards a command-and-control server or other malign location), the DNS proxy service may block the request or direct it to a block page service. If the DNS request is classified as a benign request (e.g., it is directed towards a legitimate server), the DNS proxy service may allow the resolution of the request.

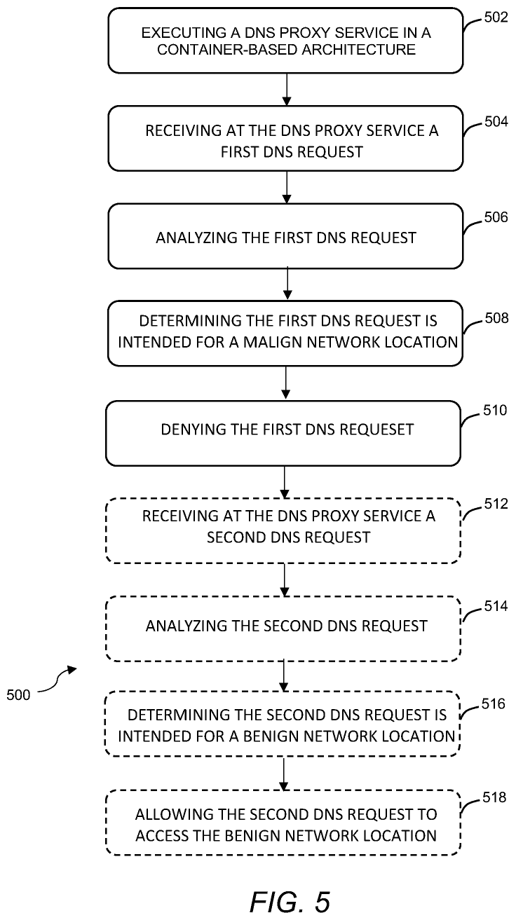

FIG. 5 depicts a flowchart of a method 500 for operating a container-based architecture in accordance with another embodiment. The systems or components of any one of FIGS. 1-3 may perform the steps of method 500.

Step 502 involves executing a DNS proxy service in a container-based architecture. The DNS proxy service of this step may be similar to the DNS proxy service 304 of FIG. 3, for example. The DNS proxy service may execute in a container-based architecture without requiring any modification or reconfiguration of other container components, such as application services.

Step 504 involves receiving at the DNS proxy service a first DNS request transmitted from a first application service executing in the container-based architecture. The first DNS request may be directed to a DNS service being executed in the same container-based architecture as the DNS proxy service. As in method 400 of FIG. 4, the DNS request may be a malicious request in that it is directed towards a malign network location.

Step 506 involves analyzing the first DNS request by comparing the first DNS request to at least one domain name associated with a malware family to determine whether the DNS request is intended for a malign network location. The embodiments herein may reference one or more databases or lists of known, malicious domains. Accordingly, step 506 may involve referencing the DNS request to domain names known to be or likely to be associated with malware.

Step 508 involves determining the first DNS request is intended for a malign network location based on the analysis of the first DNS request. This determination may be based on the DNS request matching or at least being similar to one or more malicious domain names.

Step 510 involves denying the first DNS request upon determining the first DNS request is intended for the malign network location. If the DNS request is determined to be directed towards a malign location, the DNS proxy service may prevent the DNS request from accessing the location. The DNS proxy service may instead direct the DNS request to a block page service, for example. The DNS proxy service may instead ignore the DNS request or direct the request to a sinkhole computing location.

Steps 512-518 may be optional. Step 512 involves receiving at the DNS proxy service a second DNS request transmitted from a second application service executing in the container-based architecture. The second DNS request may be directed to a DNS service being executed in the same container-based architecture as the DNS proxy service.

Step 514 involves analyzing the second DNS request by comparing the second DNS request to at least one domain name associated with a benign network location. Similar to step 506, step 514 considers whether the received second DNS request is similar to other domains that have been previously classified. Step 514, however, may consider whether the second DNS request is similar to one or more domain names associated with a benign network location. Step 514 may additionally or alternatively involve considering whether the second DNS request is similar to one or more domain names associated with a malign network location.

Step 516 involves determining the second DNS request is intended for a benign network location based on the analysis of the second DNS request. For example, the second DNS request in step 514 may have been determined to be sufficiently similar to a domain name associated with a benign location.

Step 518 involves resolving the second DNS request to allow access the benign network location. Upon determining the second DNS request is a benign request, the DNS proxy service may complete the second DNS request to allow access the desired server or other network location.

According to one aspect, embodiments herein relate to a method for operating a container-based architecture. The method includes executing, using one or more processors, instructions stored on memory to provide a Domain Name Service (DNS) proxy service, wherein the DNS proxy service is executed in a container-based architecture; receiving at the DNS proxy service a domain name service (DNS) request, wherein the DNS request is received from an application service executing in the container-based architecture and the DNS request is directed to a DNS service being executed in the same container-based architecture as the DNS proxy service; analyzing, at the DNS proxy service, the received DNS request to determine whether the DNS request is intended for a malign network location; assigning a classification to the DNS request using the DNS proxy service, wherein the assigned classification is based on the analysis of the received DNS request to determine whether the DNS request is intended for a malign network location; and resolving the DNS request to a network location based on the assigned classification of the DNS request.

In some embodiments, the DNS proxy service executing in the container-based architecture is positioned in the container-based architecture to intercept DNS requests from reaching the native DNS service and without requiring further configuration.

In some embodiments, the assigned classification indicates the DNS request is associated with a threat.

In some embodiments, the assigned classification indicates the DNS request is to a command-and-control server external to the container-based architecture or to a network location that violates a policy.

In some embodiments, the resolved network location is a sinkhole computing location.

In some embodiments, the resolved network location is a block page service.

In some embodiments, the assigned classification indicates the DNS request is to a benign network location, and resolving the DNS request to the network location includes allowing the DNS request to access the benign network location.

In some embodiments, the method further includes receiving a plurality of domain names associated with malware. In some embodiments, analyzing the received DNS request includes comparing the DNS request to the received plurality of domain names associated with malware.

According to another aspect, embodiments relate to a method for operating a container-based architecture. The method includes executing a Domain Name Service (DNS) proxy service in a container-based architecture; receiving at the DNS proxy service a first DNS request transmitted from a first application service executing in the container-based architecture, wherein the first DNS request is directed to a DNS service being executed in the same container-based architecture as the DNS proxy service; analyzing the first DNS request by comparing the first DNS request to at least one domain name associated with a malware family to determine whether the DNS request is intended for a malign network location; determining the first DNS request is intended for a malign network location based on the analysis of the first DNS request; and denying the first DNS request upon determining the first DNS request is intended for the malign network location.

In some embodiments, denying the first DNS request includes directing the first DNS request to a sinkhole computing location.

In some embodiments, denying the first DNS request includes directing the first DNS request to a block page service.

In some embodiments, denying the first DNS request includes ignoring the first DNS request.

In some embodiments, the method further includes receiving at the DNS proxy service a second DNS request transmitted from a second application service executing in the container-based architecture, wherein the second DNS request is directed to a DNS service being executed in the same container-based architecture as the DNS proxy service; analyzing the second DNS request by comparing the second DNS request to at least one domain name associated with a benign network location; determining the second DNS request is intended for a benign network location based on the analysis of the second DNS request; and allowing the second DNS request to access the benign network location.

According to yet another aspect, embodiments relate to a system for operating a container-based architecture. The system includes one or more processors executing instructions stored in memory to provide a Domain Name Service (DNS) proxy service, wherein the DNS proxy service is executed in a container-based architecture and is configured to receive a domain name service (DNS) request from an application service executing in the container-based architecture, wherein the DNS request is directed to a DNS service being executed in the same container-based architecture as the DNS proxy service; analyze the received DNS request to determine whether the DNS request is intended for a malign network location; assign a classification to the DNS request, wherein the assigned classification is based on the analysis of the DNS request to determine whether the DNS request is intended for a malign network location; and resolve the DNS request to a network location based on the assigned classification of the DNS request.

In some embodiments, the system further includes a categorization module in the container-based architecture that is configured to apply at least one categorization rule to the DNS request to assign the DNS request to a category; a domain analysis engine in the container-based architecture that is configured to compare the DNS request to a plurality of labeled domain names; and a policy server in the container-based architecture storing one or more policies, wherein the assigned classification is based on output from at least one of the categorization module, the domain analysis engine, and the policy server.

In some embodiments, the assigned classification indicates the DNS request is associated with a command-and-control server external to the container-based architecture or to a network location that violates a policy.

In some embodiments, the resolved network location is a sinkhole computing location or a block page service.

In some embodiments, the assigned classification indicates the DNS request is intended for a benign network location, and the resolved network location is the benign network location.

In some embodiments, the DNS proxy service analyzes the DNS request by comparing the DNS request to a plurality of domain names.

In this way, the foregoing methods and systems provide an improved manner for operating a container-based architecture. As discussed previously, environments using containers are often used as launch points or beachheads to carry out a malicious campaign. To prevent this, the embodiments herein inject a DNS proxy service into a container-based architecture to analyze DNS requests submitted by application services in the container-based architecture. The DNS proxy service may be positioned downstream from a DNS server without reconfiguring or modifying existing application services or pods. By acting as a filter in this location, the DNS proxy service may protect container-based architectures from being exposed to malware that results from contact with a malign location.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for operating a container-based architecture, the method comprising:
executing, using one or more processors, instructions stored on memory to provide a Domain Name Service (DNS) proxy service, wherein the DNS proxy service is executed in a container-based architecture;
receiving at the DNS proxy service a domain name service (DNS) request, wherein:
the DNS request is received from an application service executing in the container-based architecture; and
the DNS request is directed to a DNS service being executed in the same container-based architecture as the DNS proxy service;
analyzing, at the DNS proxy service, the received DNS request to determine whether the DNS request is intended for a malign network location;
assigning a classification to the DNS request using the DNS proxy service, wherein the assigned classification is based on the analysis of the received DNS request to determine whether the DNS request is intended for a malign network location; and
resolving the DNS request to a network location based on the assigned classification of the DNS request.

2. The method of claim 1, wherein the DNS proxy service executing in the container-based architecture is positioned in the container-based architecture to intercept DNS requests from reaching the native DNS service and without requiring further configuration.

3. The method of claim 1, wherein the assigned classification indicates the DNS request is associated with a threat.

4. The method of claim 1, wherein the assigned classification indicates the DNS request is to a command-and-control server external to the container-based architecture or to a network location that violates a policy.

5. The method of claim 1, wherein the resolved network location is a sinkhole computing location.

6. The method of claim 1 wherein the resolved network location is a block page service.

7. The method of claim 1, wherein the assigned classification indicates the DNS request is to a benign network location, and resolving the DNS request to the network location includes allowing the DNS request to access the benign network location.

8. The method of claim 1, further comprising receiving a plurality of domain names associated with malware.

9. The method of claim 8, wherein analyzing the received DNS request includes comparing the DNS request to the received plurality of domain names associated with malware.

10. A method for operating a container-based architecture, the method comprising:
executing a Domain Name Service (DNS) proxy service in a container-based architecture;
receiving at the DNS proxy service a first DNS request transmitted from a first application service executing in the container-based architecture, wherein the first DNS request is directed to a DNS service being executed in the same container-based architecture as the DNS proxy service;
analyzing the first DNS request by comparing the first DNS request to at least one domain name associated with a malware family to determine whether the DNS request is intended for a malign network location;
determining the first DNS request is intended for a malign network location based on the analysis of the first DNS request; and
denying the first DNS request upon determining the first DNS request is intended for the malign network location.

11. The method of claim 10, wherein denying the first DNS request includes directing the first DNS request to a sinkhole computing location.

12. The method of claim 10, wherein denying the first DNS request includes directing the first DNS request to a block page service.

13. The method of claim 10, wherein denying the first DNS request includes ignoring the first DNS request.

14. The method of claim 10, further comprising:
receiving at the DNS proxy service a second DNS request transmitted from a second application service executing in the container-based architecture, wherein the second DNS request is directed to a DNS service being executed in the same container-based architecture as the DNS proxy service;
analyzing the second DNS request by comparing the second DNS request to at least one domain name associated with a benign network location;
determining the second DNS request is intended for a benign network location based on the analysis of the second DNS request; and
allowing the second DNS request to access the benign network location.

15. A system for operating a container-based architecture, the system comprising:
one or more processors executing instructions stored in memory to provide a Domain Name Service (DNS) proxy service, wherein the DNS proxy service is executed in a container-based architecture and is configured to:
receive a domain name service (DNS) request from an application service executing in the container-based architecture, wherein the DNS request is directed to a DNS service being executed in the same container-based architecture as the DNS proxy service;
analyze the received DNS request to determine whether the DNS request is intended for a malign network location,
assign a classification to the DNS request, wherein the assigned classification is based on the analysis of the DNS request to determine whether the DNS request is intended for a malign network location, and
resolve the DNS request to a network location based on the assigned classification of the DNS request.

16. The system of claim 15 further comprising:
a categorization module in the container-based architecture that is configured to apply at least one categorization rule to the DNS request to assign the DNS request to a category;
a domain analysis engine in the container-based architecture that is configured to compare the DNS request to a plurality of labeled domain names; and
a policy server in the container-based architecture storing one or more policies, wherein the assigned classification is based on output from at least one of the categorization module, the domain analysis engine, and the policy server.

17. The system of claim 15 wherein the assigned classification indicates the DNS request is associated with a command-and-control server external to the container-based architecture or to a network location that violates a policy.

18. The system of claim 15, wherein the resolved network location is a sinkhole computing location or a block page service.

19. The system of claim 15, wherein the assigned classification indicates the DNS request is intended for a benign network location, and the resolved network location is the benign network location.

20. The system of claim 15, wherein the DNS proxy service analyzes the DNS request by comparing the DNS request to a plurality of domain names.
